(19) United States
(12) Patent Application Publication
(10) Pub. No.: US 2009/0066101 A1
(43) Pub. Date: Mar. 12, 2009

(54) Easy view tweezers

(76) Inventor: Yong-Hoon Cho, Fullerton, CA (US)

Correspondence Address: Maria Erlinda C. Sarno, Esq., P.O. Box 1023, Artesia, CA, 90702, US

(21) Appl. No.: 11/900,591

(22) Filed: Sep. 12, 2007

(51) Int. Cl. B25B 7/00

(52) U.S. Cl. 294/99.2

(57) ABSTRACT

A tweezers, comprising two identical elongated thin sheets having a stationary end and a pair of free opposing ends, the free opposing ends having a tip on each end; and, a first opening on a surface of the free opposing ends of the elongated thin sheet proximal to the tip for detecting an object pinched between the pair of free opposing ends. The tweezers can have a second opening on each surface of the free opposing end at a location behind the first opening proximal to the tip. The second opening is for accommodating a finger as it grips on the tweezers.

This invention relates to a tweezers with a viewing segment and an opening for accommodating a finger for a firmer grip.

### BACKGROUND

All tweezers in the market have a solid body or pincers. Consequently, as one plucks. an object, the user has to be careful to pick on the right object before plucking. Otherwise, it is very common to pull off the wrong object or pull off more than what is needed. This is usually encountered when a hair is pulled off from the eyebrows or when white hairs are plucked from the black hairs. With the present tweezers, there is no way of checking for the right object once this is pinched between the pincers of the tweezers. Some tweezers also have no components that will improve the grip of the user which makes the application of pressure on the fingers more tedious.

It is therefore an object of this invention to provide an opening near the tip of the tweezers which would enable a user to check if the object to be plucked is the right object.

It is also an object of this invention to provide a means for improving the grip of a user while plucking the object.

It is a further object of this invention to provide this capability for all types of tweezers.

It is still a further object of this invention to provide this tweezers with the least amount of modification so as to maintain the current cost of the tweezers.

### SUMMARY OF THE INVENTION

This invention relates to a tweezers, comprising two identical elongated thin sheets having a stationary end and a pair of free opposing ends, the free opposing ends having a tip at each end; and, a first opening on a surface of the free opposing end of the elongated thin sheet proximal to the tip for detecting an object pinched between the pair of free opposing ends. The tweezers may have a second opening on each surface of the free opposing end at a location behind the first opening proximal to the tip. The two elongated thin sheets may come from two separate sheets and the stationary end results from the fusion or welding of the two sheets together at one end. The elongated thin sheets may come from one sheet wherein the stationary end of the elongated thin sheets is looped or folded. The free opposing ends open at an angle and can be flat and straight or flat and curved. The first opening can be of different geometric shape. The distance of the first opening from the tip of the tweezers depends on the length of the object to be held between the pair of free opposing ends. This distance is usually approximately 1-5 millimeters. The tips of the tweezers are of varying shape, size and thickness depending upon its usage.

When there is a second opening, this should be at a location not obstructing the view of the first opening. The edge of the second opening proximal to the first opening is usually situated approximately eight to ten millimeters from the edge of the first directly facing the second opening. The width of the surface of the free opposing ends is recommended to be wider than the width of the stationary end when there is a second opening. The surface surrounding the second opening provide a pressing and resting place for a finger and the second opening is of a size that can accommodate a portion of the finger.

Other embodiments of the present invention will become readily apparent to those skilled in the art from the following detailed description, wherein it shows and describes only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is a perspective view of the tweezers with openings both near the tip and at a proximal end of the pincers.

FIG. 2 is a front side view of the tweezers with a piece of hair showing on the first opening near the tip.

FIG. 3 is a lateral side view of the tweezers showing the second opening at a proximal end of the pincers with a finger pressing on the opening.

FIG. 4 is a side view of the tweezers made from a single material looped at one end.

FIG. 5 is a side view of the tweezers made from a single material folded at one end.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any tweezers which has an opening on the body of the tweezers to view the object being held or plucked is within the scope of this invention. The detailed description includes specific details to provide a thorough understanding of the claimed invention and it is apparent to those skilled in the art that the claimed invention may be practiced without these specific details.

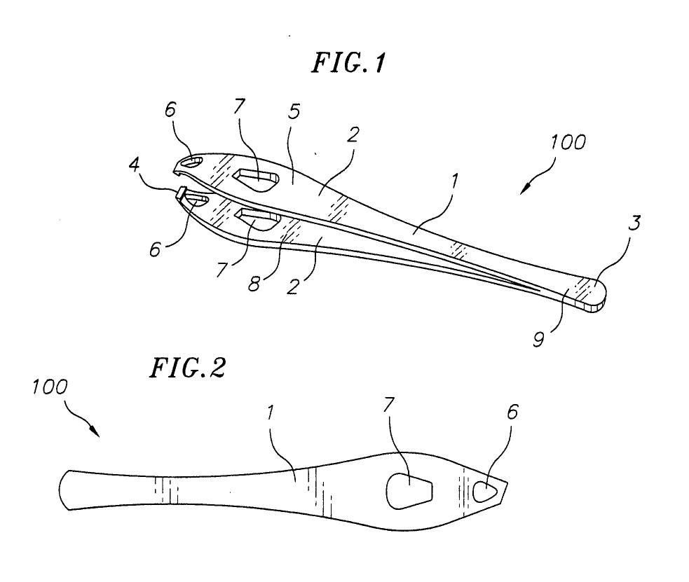

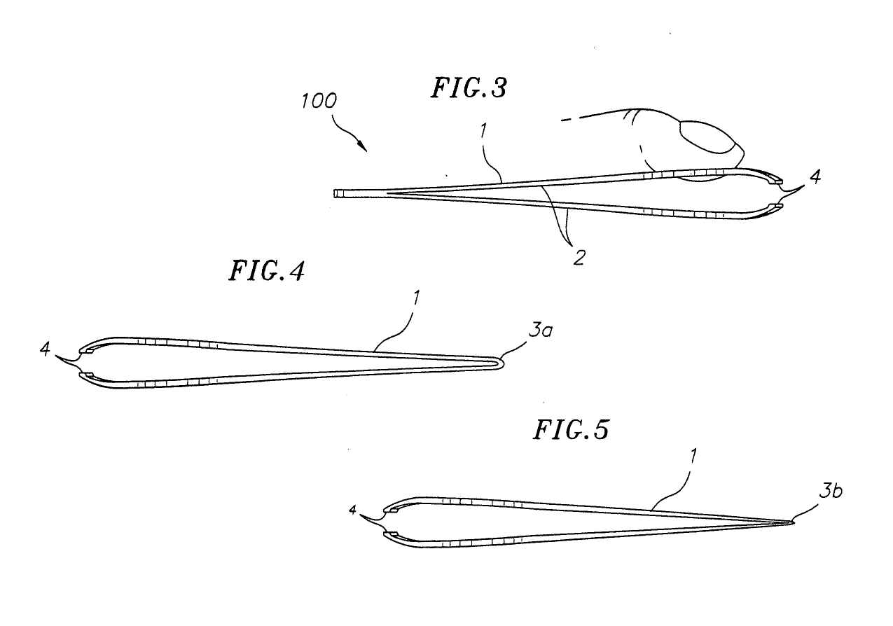

The tweezers 100 of this invention is shown in FIGS. 1-3. The body 1 of an ordinary tweezers is generally constructed from two identical elongated thin sheets 2 of metal. The two elongated sheets 2 can be from two separate sheets fused or welded together at one end to form the stationary end 3 resulting in a pair of free opposing ends. The pair of free opposing ends opposite the fused end 3 having the tips 4 is also referred to herein as the pincer 5. The free opposing ends may be flat opening at an angle from each other or it may be curved. The fusion at one end 3 causes the opposite end 5 to open up or space apart, consequently, allowing movement at this end as pressure by the fingers for example, is exerted or released at the outside surfaces of the elongated thin sheets 2 proximal to the free end 5. The body 1 differs from the present tweezers in that there is an opening 6 on each elongated thin sheet 2 at the free opposing end 5 near or proximal to the tip 4 as shown by the figures. This opening is also referred to as the first opening. This opening aids the user in detecting the object held or to be plucked as shown in FIG. 2. One opening on one elongated thin sheet may be sufficient on some applications as long as the opening 6 is on the surface 8 of the elongated thin sheet that can be seen by the eye. The opening 6 can be of any geometric shape but for aesthetic reasons is shown here as triangular to conform with the tapering shape of the tip end of the tweezers. The opening should be near the tip so that even short objects can be seen from the opening. A distance from 1-5 mm. from the back edge of the tip to the edge of the opening proximal to the tip is a good distance. This range of distance depend upon the length of the object to be held between the pincers or plucked by the tweezers.

Tweezers are used either to hold something stationary while another action is being performed or to pluck an object. Consequently, the tweezers can have different tips 4 of varying shapes, sizes and thickness for the multiple usage and applications of the tweezers. The tips can be pointed, slanted, flat, rounded, serrated, etc. Tweezers are used for example, for cosmetic purposes, usually for plucking unwanted hair, there are those used in surgery for holding or gripping tissues, blood vessels, organs and the like, there are those used in dentistry for clamping a tooth, there are those used in weaving and embroidery for plucking, holding a thread or inserting a thread, etc. In all these usage, it would be advantageous to see if the right object is being held or being plucked after they have been pinched or held between the pincers 5.

The tweezers of the claimed invention can be advantageously designed with another opening 7 on the pincers behind the first opening 6 as shown in FIGS. 1-3. A second opening 7 on each surface 8 of the pincers 5 is recommended even for those tweezers with only one opening 6. The second opening 7 is used to accommodate a portion of a finger as it presses on the pincers 5 as shown in FIG. 3. The second opening 7 provides a grip as one uses the tweezers. This is especially needed when the tweezers is used for delicate operations where accuracy is important such as in the medical usage of the tweezers. The distance between the first opening 6 and the second opening 7 should be such that the fingers after being held by the second opening, will not obstruct or cover the view of the first opening. This distance is longer for users with long fingers especially those of the thumb. A typical distance between the edge of the first opening and the edge of the second opening proximal to the first opening ranges from about eight millimeter to 10 millimeters (mm).

The placing of the second opening 7 necessarily require that the surface 8 of the pincers 5 are widened compared to the surface 9 of the stationary ends 3 as shown in FIGS. 1 and 2 to accommodate the second opening as shown. The widening of the pincers also perform a second vital function, that is, to serve as a pressing and resting place for the portion of the fingers resting at the surface surrounding the second opening. The width must be such that the sides of the fingers outside the opening 7 rest comfortably within the surface of the pincers. It would be uncomfortable to let the sides of the fingers protrude from the side edges of the pincers when it press on the tweezers during usage.

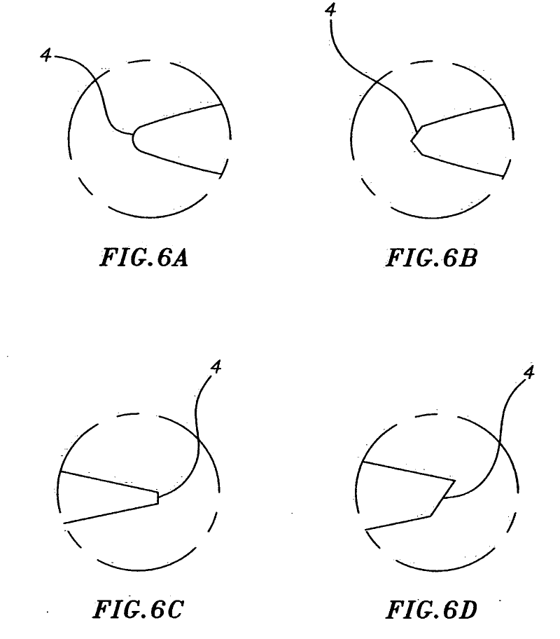

Instead of two elongated sheets fused or welded together at one end to form the tweezers, the tweezers can also be made of a single material looped at one end, much like a tong as shown in FIG. 4 or folded instead of fused as shown in FIG. 5. As in the tweezers described above formed from two separate thin sheets, the loop end 3a and the folded end 3b assumes the same role as the stationary ends 3, keeping the pair of opposing ends the same as described above.

While the embodiments of the present invention have been described, it should be understood that various changes, adaptations, and modifications may be made therein without departing from the spirit of the invention and the scope of the claims.

1. A tweezers, comprising:
two identical elongated thin sheets having a stationary end and a pair of free opposing ends, the free opposing ends having a tip at each end; and,
a first opening on a surface of one free opposing end of the elongated thin sheet proximal to the tip visible by an eve for detecting an object pinched between the pair of free opposing ends.

2. The tweezers of claim 1 further comprising a second opening on each surface of the pair of free opposing ends at a location behind the first opening proximal to the tip on the one free opposing end.

3. (canceled)

4. (canceled)

5. (canceled)

6. The tweezers of claim 1 wherein the free opposing ends are flat and straight, opening at an angle.

7. The tweezers of claim 1 wherein the free opposing ends are flat and curved, opening at an angle.

8. The tweezers of claim 1 wherein the first opening proximal to the tip have varying geometric shape.

9. The tweezers of claim 1 wherein the first opening proximal to the tip is triangular in shape.

10. The tweezers of claim 1 wherein the distance of the first opening from the tip depends on the length of an object held between the pair of free opposing ends.

11. The tweezers of claim 10 wherein the distance is approximately 1-5 millimeters.

12. The tweezers of claim 1 wherein the tips are of varying shape, size and thickness.

13. The tweezers of claim 2 wherein the second opening is at a location not obstructing the view of the first opening.

14. The tweezers of claim 2 wherein the distance between the edge of the first opening and the edge of the second opening proximal to the first opening is approximately eight to ten millimeters.

15. (canceled)

16. The tweezers of claim 2 wherein the surface surrounding the second opening provide a pressing and resting place for a finger.

17. (canceled)

18. A tweezers, comprising:
two identical elongated thin sheets having a stationary end and a pair of free opposing ends, the free opposing ends having a tip on each end;
a first opening on a surface of the free opposing ends of the elongated thin sheet proximal to the tip at a distance from the tip of approximately 1-5 millimeters for detecting an object pinched between the pair of free opposing ends; and,
a second opening on each surface of the free opposing end at a location behind the first opening proximal to the tip not obstructing the view of the first opening.

19. The tweezers of claim 18 wherein the second opening is at a distance between the edge distal to the tip of the first opening and the edge of the second opening proximal to the first opening of at least approximately eight millimeters.

20. (canceled)

21. The tweezer of claim 18 wherein the tips are of varying shape, size and thickness.

22. A tweezers, comprising:
two identical elongated thin sheets having a stationary end and a pair of free opposing ends, the free opposing ends having a tip at each end;
a first opening on a surface of one free opposing end of the elongated thin sheet proximal to the tip visible by an eye for detecting an object pinched between the pair of free opposing ends at a distance dependent upon the length of the object; and,
a second opening on each surface of the pair of free opposing ends at a location approximately at least 8 millimeters measured from the edge distal to the tip of the first opening located on the free opposing end having the first opening.

23. The tweezers of claim 22 wherein the free opposing ends are flat and straight, opening at an angle.

24. The tweezers of claim 22 wherein the free opposing ends are flat and curved, opening at an angle.

25. The tweezers of claim 22 wherein the tips are of varying shape, size and thickness.

26. The tweezers of claim 22 wherein the distance of the first opening from the tip is approximately 1-5 millimeters.
